(19) United States
(12) Patent Application Publication
(10) Pub. No.: US 2007/0021925 A1
(43) Pub. Date: Jan. 25, 2007

(54) Method and apparatus for searching for protein amphiphilic secondary structure region

(75) Inventor: Toru Shishiki, Tokyo (JP)

Correspondence Address: Reed Smith LLP, Suite 1400, 3110 Fairview Park Drive, Falls Church, VA, 22042-0681, US

(73) Assignee: Hitachi Software Engineering Co., Ltd.

(21) Appl. No.: 11/443,003

(22) Filed: May 31, 2006

(30) Foreign Application Priority Data
Jul. 25, 2005 (JP) 2005-214426

(51) Int. Cl. G06F 19/00

(52) U.S. Cl. 702/19

(57) ABSTRACT

When the secondary structure is an α-helix, moving averages of hydrophobic value are calculated respectively for odd-numbered amino acid residues and even-numbered amino acid residues in an amino acid sequence to be analyzed, and broken line graphs are created from the moving averages. When the secondary structure is a β-sheet, moving averages of hydrophobic value are calculated respectively for amino acid residues appearing every 3.6 residues and amino acid residues shifted 1.8 residues therefrom in the amino acid sequence to be analyzed, and broken line graphs are created from the moving averages. In the cases of α-helix and β-sheet, a region where one of the two broken lines is at a level higher than a predetermined threshold is determined as a secondary structure region candidate. Among secondary structure region candidates, a region where a distance between the two broken lines (amphiphilic value A) is larger than a predetermined threshold is determined as an amphiphilic secondary structure region candidate.

### BACKGROUND OF THE INVENTION

1. Field of the Invention

The present invention relates to a technique of analyzing secondary structures of proteins, and particularly to a technique of searching for amphiphilic secondary structures.

2. Description of Related Art

Protein is made up of several tens to several hundreds of amino acids selected from about 20 different kinds of amino acids each consisting of a main chain of common structure and a side chain having various chemical structures. Such protein forming amino acids are connected in a string, and such a string twistingly folds to form a complicated steric high-order structure. Diversity in surface characteristics represented by profiles and hydrophobicity of such high-order structure realizes a variety of chemical reactions in organisms.

In recent years, a vast number of protein three-dimensional structures have been known using various experimental methods such as nuclear magnetic resonance (NMR) or X-ray structure analysis even though they are principally in crystalline phases. Such outcomes have demonstrated that many parts of protein high-order structures are formed by combinations of characteristic local structural secondary structures each consisting of an assembly of several to several tens of amino acids.

Representative secondary structures include α-helix which is a helix structure in which a molecule formed of peptide chain amino acid residues connected in a chain forms a spiral structure, and β-sheet which is a sheet structure in which side chains are alternately oriented in opposite directions.

In many kinds of proteins, it is known that the existence of a characteristic secondary structure realizes a structure that exerts a characteristic function. For example, it is known that membrane penetration in membrane protein is often relied on an α-helix made up of 20 to 25 amino acids having hydrophobic residues.

In other words, knowing existence of a characteristic protein secondary structure will inversely allow prediction of a protein structure, and thus a function of the protein.

Various approaches for predicting secondary structures of protein have been devised. One of such approaches is to predict a transmembrane secondary structure region in a membrane protein located in a membrane which is a hydrophobic environment, and in such an approach, hydropathy plotting is used. Hydropathy plotting is described in Kyte, J. & Doolittle, R. F. 1982. In the hydropathy plotting, hydrophobicity/hydrophilicity is experimentally determined for each side chain of 20 kinds of amino acids, and an index (KD index) is constructed therefrom, and amino acid sequence number is plotted on the horizontal axis and moving average of KD index is plotted on the vertical axis. Moving average of n-th amino acid residue is usually determined by averaging KD indexes of a sequence of contiguous five amino acids.

[Patent document 1] Japanese Patent Application Laid-Open No. 2002-215634

[Patent document 2] Japanese Patent Application Laid-Open No. 2002-286725

With the trend that DNA sequencing is actively propelled for many organisms as is represented by completion of draft sequences of human genome, it becomes more important to know information of a protein encoded by a determined DNA sequence, and a great number of programs have been developed for predicting a coding region or for predicting secondary structures of protein.

However, there is no method that achieves region search focusing on an amphiphilic secondary structure in a protein secondary structure.

### SUMMARY OF THE INVENTION

It is an object of the present invention to provide means for searching for a region of amphiphilic secondary structure in a protein secondary structure.

According to the present invention, a method for searching for an amphiphilic secondary structure region in protein includes an input step for inputting an amino acid sequence to be analyzed via an input device and selecting α-helix or β-sheet as a secondary structure; a first calculation step for calculating a moving average of hydrophobic value of odd-numbered amino acid residues in the amino acid sequence to be analyzed, and a moving average of hydrophobic value of even-numbered amino acid residues in the amino acid sequence to be analyzed, respectively as a first moving average and a second moving average, when α-helix is selected as the secondary structure; a second calculation step for calculating a moving average of hydrophobic value of a first set of amino acid residues appearing every 3.6 residues in the amino acid sequence to be analyzed, and a moving average of hydrophobic value of a second set of amino acid residues appearing every 3.6 residues in the amino acid sequence to be analyzed and each shifted 1.8 residues from the first set of amino acid residues appearing every 3.6 residues, respectively, as a third moving average and a fourth moving average, when β-sheet is selected as the secondary structure; a broken line graph creation step for plotting the moving averages of hydrophobic value of amino acid residues on a coordinate in which a vertical axis represents hydrophobic value and a horizontal axis represents number of amino acid residue, to create a first broken line graph for the first moving average; a second broken line graph for the second moving average; a third broken line graph for the third moving average; and a fourth broken line graph for the fourth moving average; and a display step for displaying the broken line graphs on a screen.

According to the present invention, it becomes possible to search for an amphiphilic secondary structure from an amino acid sequence which is a primary structure of protein.

### BRIEF DESCRIPTION OF THE DRAWINGS

FIG. 1 is a system configuration diagram of an amphiphilic secondary structure searching apparatus according to the present invention;

FIG. 2 is a view showing one example of an amphiphilic β-sheet structure;

FIG. 3 is a view showing one example of an amphiphilic α-helix structure;

FIG. 4 is an illustrative view for illustrating an example of filtering a candidate region for amphiphilic secondary structure by an amphiphilic secondary structure searching method according to the present invention;

FIG. 5 is a view showing one example of a user interface for amphiphilic secondary structure searching;

FIG. 6 is a flow chart of a method for searching for a amphiphilic secondary structure candidate region according to the present invention; and

FIG. 7 is a view showing one example of file format of input data in an amphiphilic secondary structure searching apparatus according to the present invention.

### DETAILED DESCRIPTION OF THE PREFERRED EMBODIMENT

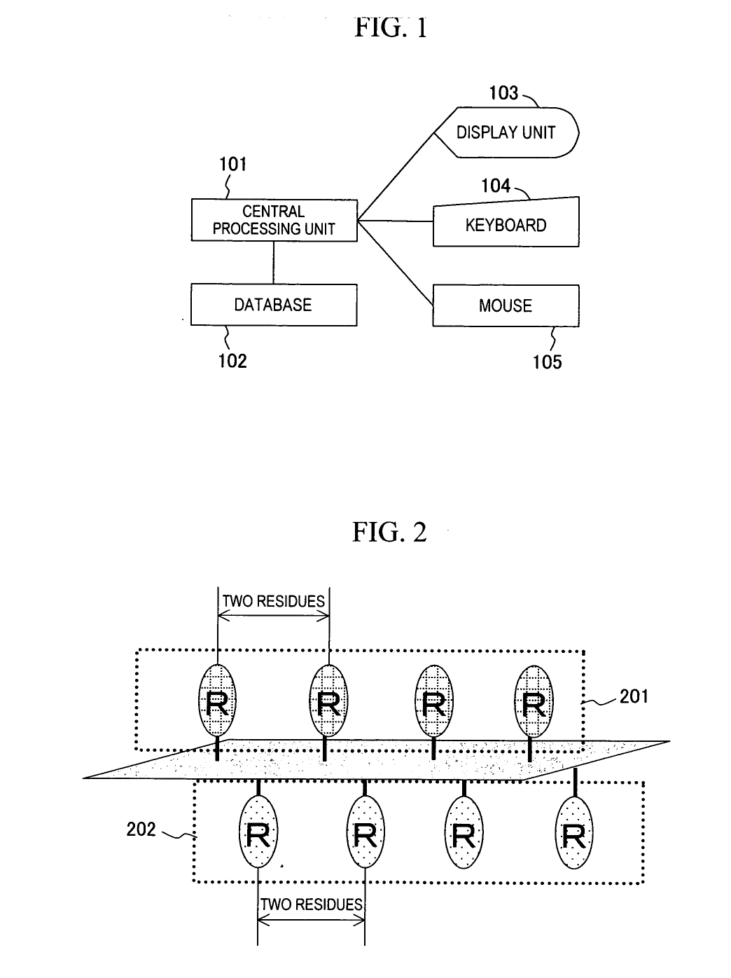

In the following, an embodiment of the present invention will be explained in detail with reference to the attached drawings. FIG. 1 is block diagram showing a configuration of an amphiphilic secondary structure searching system according to one embodiment of the present invention. As shown in FIG. 1, the amphiphilic secondary structure searching system of the present embodiment is a stand-alone system including a central processing unit (hereinafter abbreviated as “CPU”) 101, a database 102, a display unit 103, a key board 104 and a mouse 105.

A user inputs an arbitrary amino acid sequence using the key board 104 and the mouse 105. The CPU 101 detects a candidate region for amphiphilic secondary structure contained in the input amino acid sequence, and depicts the amphiphilic secondary structure candidate region in the display unit 103.

FIG. 2 shows an amphiphilic β-sheet structure which is one example of amphiphilic secondary structure. The amphiphilic β-sheet structure is a β-sheet structure having a hydrophobic face and a hydrophilic face. In a β-sheet structure, side chains of amino acids are alternately located at angles of 180 degrees. Therefore, in an amphiphilic β-sheet structure, an amino acid 201 having a hydrophilic side chain and an amino acid 202 having a hydrophobic side chain each appears every two residues.

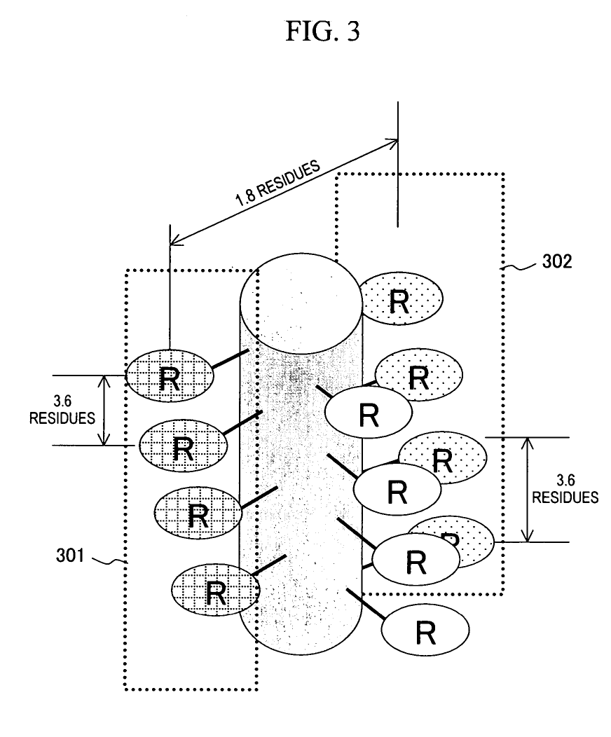

FIG. 3 shows an amphiphilic α-helix structure as one example of amphiphilic secondary structure. The amphiphilic α-helix structure is an α-helix structure having a hydrophobic face and a hydrophilic face. In an α-helix structure, side chains of amino acids are positioned such that they project from a cylinder while turning outside the cylinder by 100 degrees. Therefore, in an amphiphilic α-helix structure, an amino acid 301 having a hydrophilic side chain and an amino acid 302 having a hydrophobic side chain each appears every 3.6 residues. The amino acid 301 having a hydrophilic side chain is shifted 180 degrees (1.8 residues) from the amino acid 302 having a hydrophobic side chain.

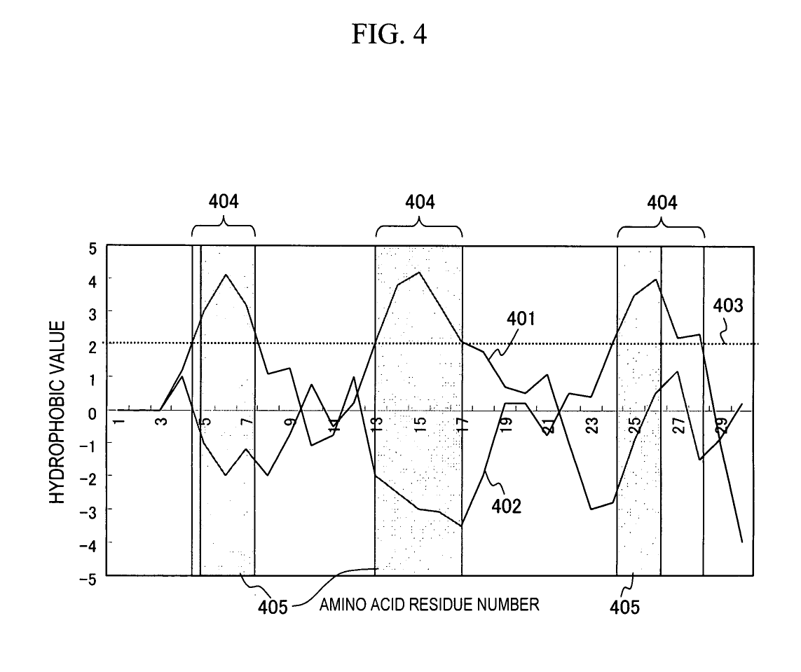

Referring now to FIG. 4, an example of filtering of amphiphilic secondary structure candidate regions will be explained. The horizontal axis of FIG. 4 represents numbers of all residues of an amino acid sequence to be analyzed, and the vertical axis represents hydrophobic value of each amino acid residue. When the hydrophobic value is positive, the amino acid residue is hydrophobic, and when the hydrophobic value is negative, the amino acid residue is hydrophilic. In other words, the area above the horizontal axis are defined as hydrophobicity, and the area below the horizontal axis is defined as hydrophilicity. The broken lines are hydropathy plotting.

First, explanation will be given on the case of β-sheet structure. As described above, in the β-sheet structure, amino acid 201 having a hydrophilic side chain and amino acid 202 having a hydrophobic side chain each appears every two residues. Accordingly, in the β-sheet structure, a moving average of hydrophobic value of amino acid residues picked out every two residues would exhibit either hydrophobicity or hydrophilicity. For example, if an odd-numbered amino acid residue has a hydrophobic value exhibiting hydrophobicity, an even-numbered amino acid residue will have a hydrophobic value exhibiting hydrophilicity. Contrarily, if an even-numbered amino acid residue has a hydrophobic value exhibiting hydrophobicity, an odd-numbered amino acid residue will have a hydrophobic value exhibiting hydrophilicity.

Putting hydrophobic value of n-th amino acid residue as “h”, and moving average of the hydrophobic value as “H”, the moving average H can be obtained according to the following formula:
Hₙ=(hₙ₋₄+hₙ₋₂+hₙ+hₙ₊₂+hₙ₊₄)/5 [Formula 1]

The subscripts n−4, n−2, n, n+2 to the hydrophobic value “h” denote numbers of amino acid residues. When “n” is an even number, moving average of hydrophobic value of 2nd, 4th, 6th, 8th, . . . 2n-th, i.e., of even-numbered amino acid residues can be obtained. When “n” is an odd number, moving average of hydrophobic value of 1st, 3rd, 5th, 7th . . . (2n−1)-th, i.e., of odd-numbered amino acid residues can be obtained.

In this manner, by calculating a moving average of hydrophobic value for every residue of an amino acid sequence, and plotting moving averages of odd-numbered amino acid residues on the graph, one broken line 401 is depicted. Next, moving averages of even-numbered amino acid residues are plotted on the same graph to depict another broken line 402.

In these two broken lines 401, 402, when the moving average of hydrophobic value keeping greater than or equal to a predetermined threshold 403 continues for an area of a predetermined length or longer, such region of amino acid sequence is defined as a secondary structure region candidate 404.

Next, amphiphilic value A of n-th amino acid residue is defined by the following formula.
A=|H(a)ₙ−H(b)ₙ| [Formula 2]

Here, H(a)ₙ, is a value of n-th amino acid residue in the broken line 401, and H(b)ₙ, is a value of n-th amino acid residue in the broken line 402. Therefore, amphiphilic value A represents a distance between the two broken lines 401 and 402. When the distance between the two broken lines 401 and 402 is large, the amphiphilic value A is large, so that it can be considered that the possibility of possessing both hydrophobicity and hydrophilicity is high. When the distance between the two broken lines 401 and 402 is small, the amphiphilic value A is small, so that it can be considered that the possibility of possessing both hydrophobicity and hydrophilicity is small.

When the amphiphilic value A keeping greater than or equal to a predetermined threshold continues for an area of a predetermined length or longer within the secondary structure region candidate 404, such region of amino acid sequence is defined as an amphiphilic candidate region 405.

Next, explanation will be given on the case of α-helix structure. As described above, in the α-helix structure, amino acid 301 having a hydrophilic side chain and amino acid 302 having a hydrophobic side chain each appears every 3.6 residues. Accordingly, in an α-helix structure, a moving average of hydrophobic value of amino acid residues picked out every 3.6 resides would exhibit either hydrophobicity or hydrophilicity.

Putting hydrophobic value of n-th amino acid residue as “h”, and moving average of the hydrophobic value as “H”, the moving average H can be obtained according to the following formula:
Hₙ=(h_{n-7.2}+h_{n-3.6}+hₙ+h_{n+3.6}+h_{n+7.2})/5 [Formula 3]

The subscripts n−7.2, n−3.6, n, n+3.6, n+7.2 to the hydrophobic value “h” denote numbers of amino acid residues. “n” is an integer. Accordingly, Formula 3 represents a moving average of hydrophobic value of n-th (n is an integer) amino acid resides. In the cases of amino acid residues other than n-th, namely amino acid residues of numbers with decimal, moving average H of hydrophobic value can be obtained by the following formula.
Hₙ₊ₖ=Hₙ+k×(Hₙ+Hₙ) [Formula 4]

In the above formula, “n” is an integer, and “k” is a decimal of less than 1. As represented in Formula 4, moving average H of hydrophobic value of (n+k)th amino acid residue is an weighed average of moving averages of integer-numbered amino acid residues on both sides. For instance, moving average H of hydrophobic value of (n+3.6)th (n is an integer) amino acid residue can be obtained by the following formula.
H_{n+3.6}=Hₙ+3.6×(Hₙ₊₁−Hₙ) [Formula 5]

In this manner, moving averages of hydrophobic value are determined and plotted on a graph for every residue of an amino acid sequence. Here, an amino acid residue serving as a reference is selected. In an α helix structure, both a hydrophilic residue and a hydrophobic residue appear every 3.6 residues, and the difference between a hydrophilic residue and a hydrophobic residue is 1.8 residues. Therefore, by plotting moving averages of 3.6th, 7.2nd, . . . , amino acid residues from the reference amino acid residue on the graph, one broken line 401 is depicted. By plotting moving averages of 1.8th, 5.4th, 9th . . . , amino acid residues from the reference amino acid residue on the graph, another broken line 402 is depicted. The one broken line 401 represents moving averages of hydrophobicity of residues on one side of the helix, while said another broken line 402 represents moving averages of hydrophobicity of residues on the other side of the helix.

In the broken lines 401, when the moving average of hydrophobic value keeping greater than or equal to a predetermined threshold 403 continues for a region of a predetermined length or longer, such region of amino acid sequence is defined as a secondary structure region candidate 404.

Next, amphiphilic value A of n-th amino acid residue is defined by the following formula.
A=|H(a)ₙ−H(b)ₙ| [Formula 6]

When the amphiphilic value A keeping greater than or equal to a predetermined threshold continues for a region of a predetermined length or longer within the secondary structure candidate region 404, such region of amino acid sequence is defined as an amphiphilic secondary structure candidate region.

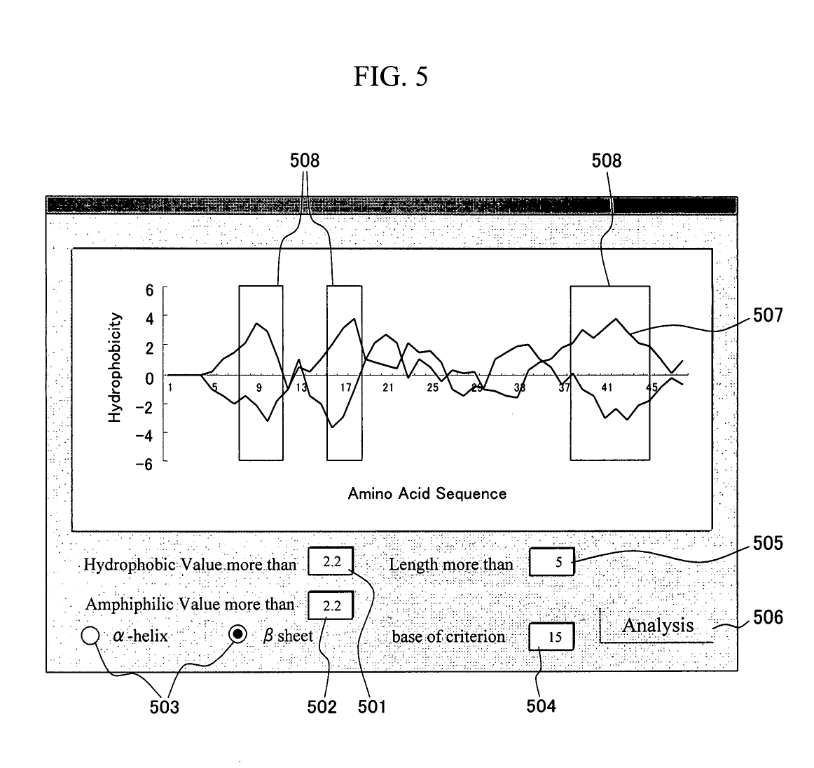

FIG. 5 is an example of a screen displayed by the display unit 103 during amphiphilic secondary structure searching according to the present invention. In an upper part of this screen, a graph in which moving averages of hydrophobic value are plotted for every residue in an amino acid sequence to be analyzed, namely hydropathy plotting 507 and amphiphilic secondary structure candidate regions 508 are displayed.

In this screen, also displayed are a text box 501 for setting a threshold of hydrophobic value (threshold 403 in FIG. 4), a text box 502 for setting a threshold of amphiphilic value A, a radio button 503 for allowing selection between α-helix structure and β-sheet structure, a text box 504 for setting an amino acid serving as a reference when α-helix structure is selected, a text box 505 for setting a minimum base length of an amphiphilic secondary structure candidate region, and a button 506 for starting an analysis.

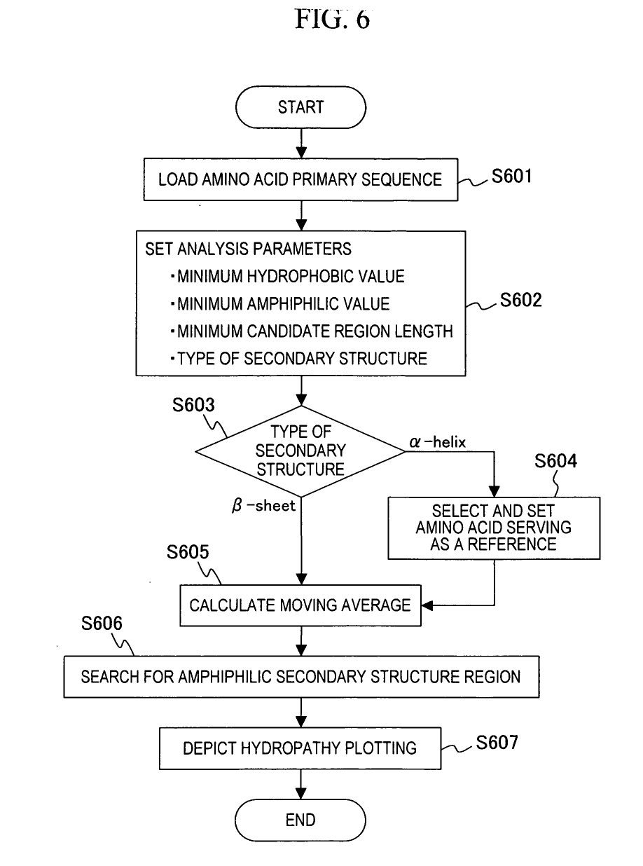

FIG. 6 is a flowchart of a method for searching for an amphiphilic secondary structure candidate region according to the present invention. First, at Step 601, a primary amino acid sequence to be analyzed is input. The input data may be acquired from database or file, or may be manually input. Then at Step 602, analysis parameters are set. Analysis parameters include a minimum hydrophobic value, a minimum amphiphilic value, a minimum candidate region length, and a type of secondary structure.

The minimum hydrophobic value is input in the text box 501 in the screen of FIG. 5, the minimum amphiphilic value is input in the text box 502 of the screen of FIG. 5, the minimum candidate region length is input in the text box 505 of the screen of FIG. 5, and the type of secondary structure is selected with the radio button 503 in the screen of FIG. 5.

At Step 603, whether the type of secondary structure set as an analysis parameter is α-helix structure or β-sheet structure is determined. When it is α-helix structure, the flow proceeds to Step 604 where an amino acid residue serving as a reference is set. The amino acid residue serving as a reference is input in the text box 504 in the screen of FIG. 5. The flow proceeds to Step 605 after setting the amino acid residue serving as a reference in this manner. When the set secondary structure is β-sheet structure, the flow directly proceeds to Step 605.

At Step 605, a moving average of hydrophobic value is calculated for every residue in amino acid sequence to be analyzed. At Step 606, searching for amphiphilic secondary structure regions is conducted. Then at Step 607, a broken line of the hydropathy plotting and amphiphilic secondary structure candidate regions shown in FIG. 4 are depicted and displayed.

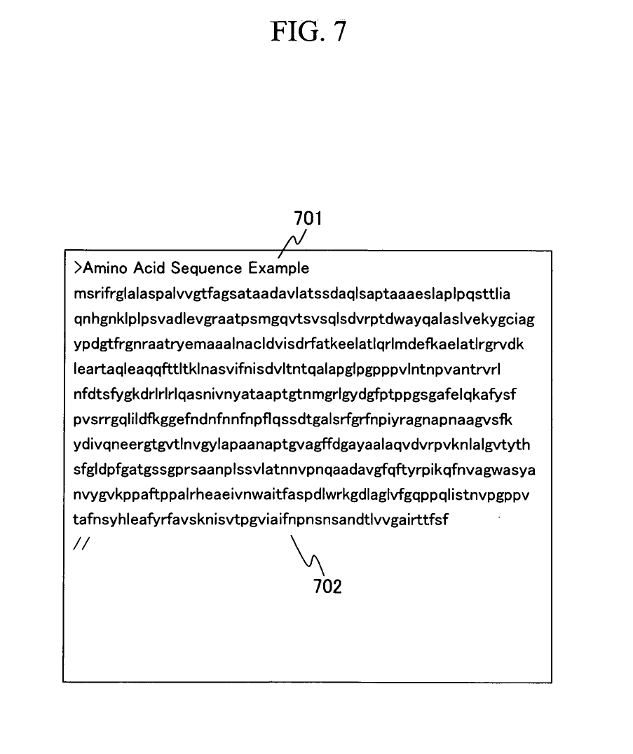

FIG. 7 shows one example of file format of input data, which is a commonly used FASTA format. The input data contains an amino acid sequence name 701 and a sequence 702.

In the above, explanation was made on a certain embodiment of the present invention, however, the ones skilled in the art will recognize that the present invention is not limited to the above embodiment but may be modified in various ways within the scope of the present invention defined in the appended claims.

What is claimed is:

1. A method for searching for an amphiphilic secondary structure region in protein, comprising:
an input step for inputting an amino acid sequence to be analyzed via an input device and selecting α-helix or β-sheet as a secondary structure;
a first calculation step for calculating a moving average of hydrophobic value of odd-numbered amino acid residues in the amino acid sequence to be analyzed, and a moving average of hydrophobic value of even-numbered amino acid residues in the amino acid sequence to be analyzed, respectively as a first moving average and a second moving average, when α-helix is selected as the secondary structure;
a second calculation step for calculating a moving average of hydrophobic value of a first set of amino acid residues appearing every 3.6 residues in the amino acid sequence to be analyzed, and a moving average of hydrophobic value of a second set of amino acid residues appearing every 3.6 residues in the amino acid sequence to be analyzed and each shifted 1.8 residues from the first set of amino acid residues appearing every 3.6 residues, respectively, as a third moving average and a fourth moving average, when β-sheet is selected as the secondary structure;
a broken line graph creation step for plotting the moving averages of hydrophobic value of amino acid residues on a coordinate in which a vertical axis represents hydrophobic value and a horizontal axis represents number of amino acid residue, to create a first broken line graph for the first moving average; a second broken line graph for the second moving average; a third broken line graph for the third moving average; and a fourth broken line graph for the fourth moving average; and
a display step for displaying the broken line graphs on a screen.

2. The method for searching for an amphiphilic secondary structure region in protein, further comprising:
comparing the first broken line graph with a first threshold, and determining as a β-sheet secondary structure region candidate a region whose value of broken line graph is greater than the first threshold for a region of a predetermined or longer in the first broken line graph;
determining a region where a difference between the first broken line graph and the second broken line graph is larger than a second threshold in the β-sheet secondary structure region candidate as an amphiphilic β-sheet secondary structure candidate region; and
displaying the β-sheet secondary structure region candidate and the amphiphilic β-sheet secondary structure candidate region together with the broken line graphs.

3. The method for searching for an amphiphilic secondary structure region in protein, further comprising:
comparing the third broken line graph with a third threshold, and determining as an α-helix secondary structure region candidate a region whose value of broken line graph is greater than the third threshold in the third broken line graph;
determining a region where a difference between the third broken line graph and the fourth broken line graph is larger than a fourth threshold in the α-helix secondary structure region candidate as an amphiphilic α-helix secondary structure candidate region; and
displaying the α-helix secondary structure region candidate and the amphiphilic α-helix secondary structure candidate region together with the broken line graphs.


SEQUENCE LISTING (1 sequence)

SEQ ID NO: 1 - protein, 592 aa, Artificial Sequence
  Amino Acid Sequence chemically synthesized
MSRIFRGLALASPALVVGTFAGSATAADAVLATSSDAQLSAPTAAAESLAPLPQSTTLIAQNHGNKLPLPSVADLEVGRAATPSMGQVTSVSQLSDVRPTDWAYQALASLVEKYGCIAGYPDGTFRGNRAATRYEMAAALNACLDVISDRFATKEELATLQRLMDEFKAELATLRGRVDKLEARTAQLEAQQFTTLTKLNASVIFNISDVLTNTQALAPGLPGPPPVLNTNPVANTRVRLNFDTSFYGKDRLRLRLQASNIVNYATAAPTGTNMGRLGYDGFPTPPGSGAFELQKAFYSFPVSRRGQLILDFKGGEFNDNFNNFNPFLQSSDTGALSRFGRFNPIYRAGNAPNAAGVSFKYDIVQNEERGTGVTLNVGYLAPAANAPTGVAGFFDGAYAALAQVDVRPVKNLALGVTYTHSFGLDPFGATGSSGPRSAANPLSSVLATNNVPNQAADAVGFQFTYRPIKQFNVAGWASYANVYGVKPPAFTPPALRHEAEIVNWAITFASPDLWRKGDLAGLVFGQPPQLISTNVPGPPVTAFNSYHLEAFYRFAVSKNISVTPGVIAIFNPNSNSANDTLVVGAIRTTFSF